(19) United States
(12) Patent Application Publication
(10) Pub. No.: US 2007/0056493 A1
(43) Pub. Date: Mar. 15, 2007

(54) Electrical conductor element

(75) Inventors: John Burkitt, Woking (GB); Stuart Mark Walkington, Hertfordshire (GB)

Correspondence Address: HARNESS, DICKEY & PIERCE, P.L.C., P.O. BOX 828, BLOOMFIELD HILLS, MI, 48303, US

(73) Assignee: Eleksen Limited, Hertfordshire (GB)

(21) Appl. No.: 11/517,483

(22) Filed: Sep. 7, 2006

(30) Foreign Application Priority Data
Sep. 9, 2005 (GB) 0518371.0

(51) Int. Cl. B32B 7/08; D05C 17/00

(52) U.S. Cl. 112/429; 112/401; 112/402; 112/415; 112/418

(57) ABSTRACT

A position sensor is shown for detecting the position of a mechanical interaction. The sensor includes a first conductive fabric layer having electrically conductive fibres incorporated therein to allow conduction in a first direction. The first conductive fabric layer has a first electrical conductor element a and a second electrical conductor element positioned at opposite ends of a first conductive path extending in a first direction. The first and second electrical conductor elements each comprise a length of electrically conductive thread machined to form a conductive track of stitches that extends in a second direction substantially perpendicular to the first direction. The first and second electrical conductor elements do not intersect.

### CROSS REFERENCE TO RELATED APPLICATION

This application claims priority from United Kingdom Patent Application No. 0518371.0, filed 09 Sep. 2005, the entire disclosure of which is incorporated herein by reference in its entirety.

### FIELD OF THE INVENTION

The present invention relates to an electrical conductor element, in particular to a flexible electrically conductive fabric conductor element for making electrical connection to a flexible conductive fabric sensor.

### DESCRIPTION OF THE RELATED ART

Figure A shows layers of a flexible position sensor A01 having a first conductive fabric layer A02, a second conductive fabric layer A03 and an intermediate separating layer A04 disposed between the first conductive fabric layer A02 and the second conductive fabric layer A03. The intermediate separating layer A04 is configured to separate the first conductive fabric layer A02 and the second conductive fabric layer A03 in the absence of a mechanical interaction with the position sensor A01. The intermediate separating layer A04 is also penetrable by one of the first conductive fabric layer A02 and the second conductive fabric layer A03 during a mechanical interaction to allow the first conductive fabric layer A02 and the second conductive fabric layer A03 to make electrical contact. The first conductive fabric layer A02 includes conductive fibres arranged such that the first conductive layer is conductive in a first direction A05, along the layer. The second conductive fabric layer A03 also includes conductive fibres arranged such that the second conductive layer is conductive in a second direction A06, along the layer. In the arrangement shown, the first direction A05 and the second direction A06 are substantially perpendicular.

The first conductive fabric layer A02 is provided with a first conductive element A07 and a second conductive element A08, positioned at opposed ends of a conductive path extending in the first direction A05. Similarly, the second conductive fabric layer A03 is provided with a third conductive element A09 and a fourth conductive element A10, positioned at opposed ends of a conductive path extending in the second direction A06.

The conductive elements A07, A08, A09, A10 of the position sensor A01 are fabricated from a strip of conductive fabric incorporating metal particles. The conductive elements A07, A08, A09, A10 are laid onto the relevant conductive fabric layer and attached thereto by means of conductive adhesive.

A position sensor having this layer construction is disclosed in GB 2 350 431 B. A position sensor having a layer construction incorporating an additional layer between the central layer and each outer layer is disclosed in U.S. Pat. No. 6,452,479 B.

The accuracy of position determination depends on the maintenance of a uniform electrical contact between each conductive element and the conductive fabric layer to which it is attached. A problem with using a metallised strip of conductive fabric for the conductive elements of a flexible position sensor is that the use, and flexing and bending of the position sensor causes the metallised strips and the adhesive connection to the conductive fabric layer to wear. This wear causes degradation of the electrical contact between the metallised strip and the conductive fabric layer to which it is attached, reducing the accuracy of the position determination of a mechanical interaction.

### BRIEF SUMMARY OF THE INVENTION

A position sensor for detecting the position of a mechanical interaction, includes a first conductive fabric layer having electrically conductive fibres incorporated therein to allow conduction in a first direction, the first conductive fabric layer having a first electrical conductor element and a second electrical conductor element positioned at opposed ends of a first conductive path extending in the first direction. The first electrical conductor element and the second electrical conductor element each comprise a length of electrically conductive thread machined to form a conductive track of stitches that extends in a second direction substantially perpendicular to the first direction with a zigzag stitch pattern. The first and second electrical conductor elements do not intersect.

### BRIEF DESCRIPTION OF THE SEVERAL VIEWS OF THE DRAWINGS

Figure A is a schematic of a prior art position sensor showing layers thereof in an exploded view,

FIG. 1 shows a flexible position sensor,

FIG. 2 shows flexible layers of the position sensor of FIG. 1,

FIG. 3 shows illustrates an arrangement of electrical connections between layers of FIG. 2 and a control circuit,

FIG. 4 shows a conductive thread,

FIGS. 5A, 5B, 5C & 5D illustrate a stitched thread,

FIG. 6 shows a flexible electrically conductive fabric conductor element connected to a conductive fabric layer of the position sensor of FIG. 1, and

FIG. 7 shows a conductive tape connected to a conductive fabric layer of the position sensor of FIG. 1.

### WRITTEN DESCRIPTION OF THE BEST MODE FOR CARRYING OUT THE INVENTION

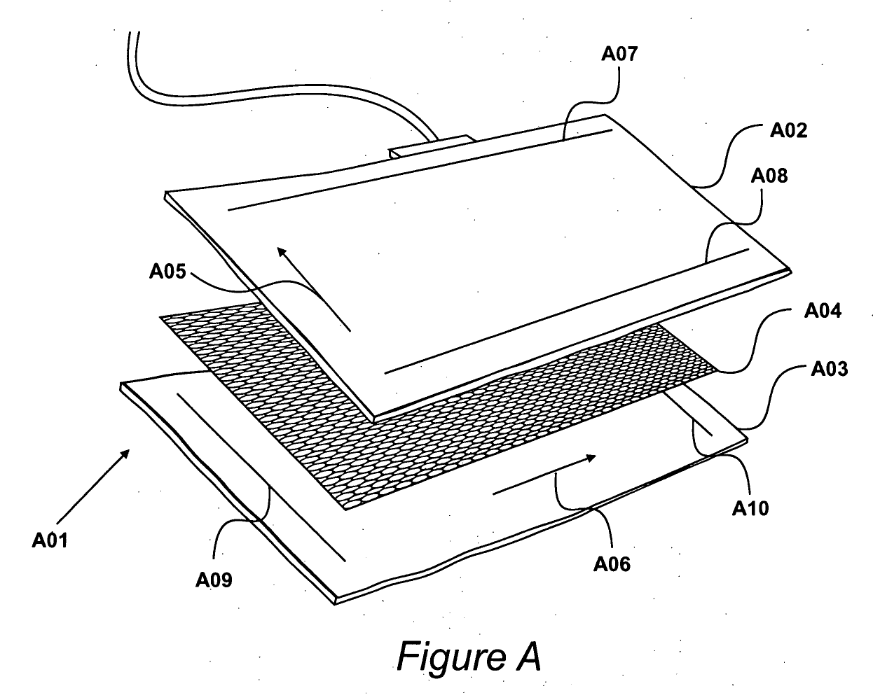

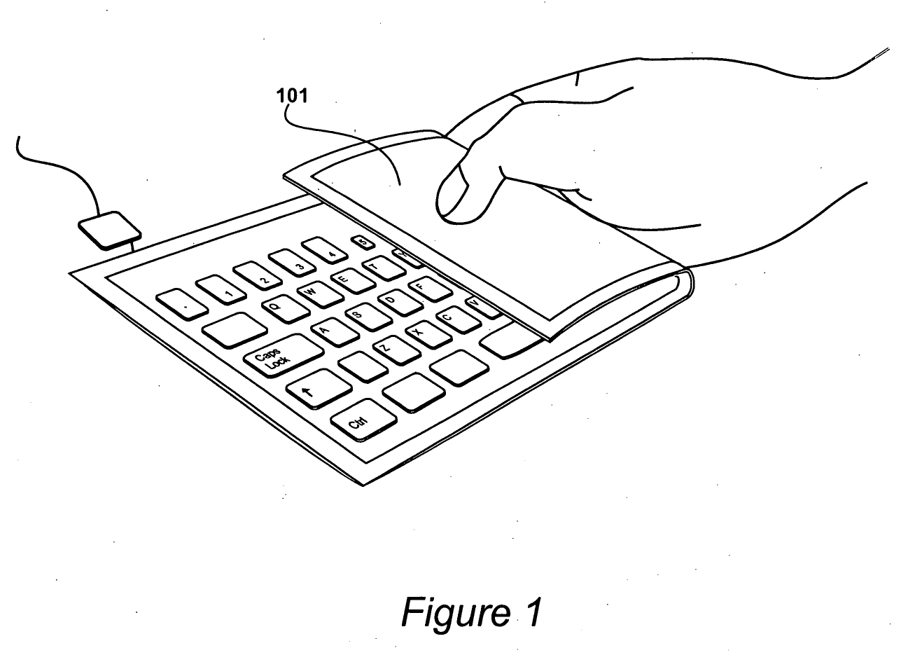

FIG. 1

A flexible position sensor is shown in FIG. 1. Portable sensor 101 is a peripheral data input device, in the form of an alphanumeric keyboard, for a mobile telephone or other electronic processing device. The portable sensor 101 is flexible to allow it to be folded for convenient transportation and storage. The sensor 101 is therefore required to withstand repeated bending and folding operations to provide a working life of satisfactory length.

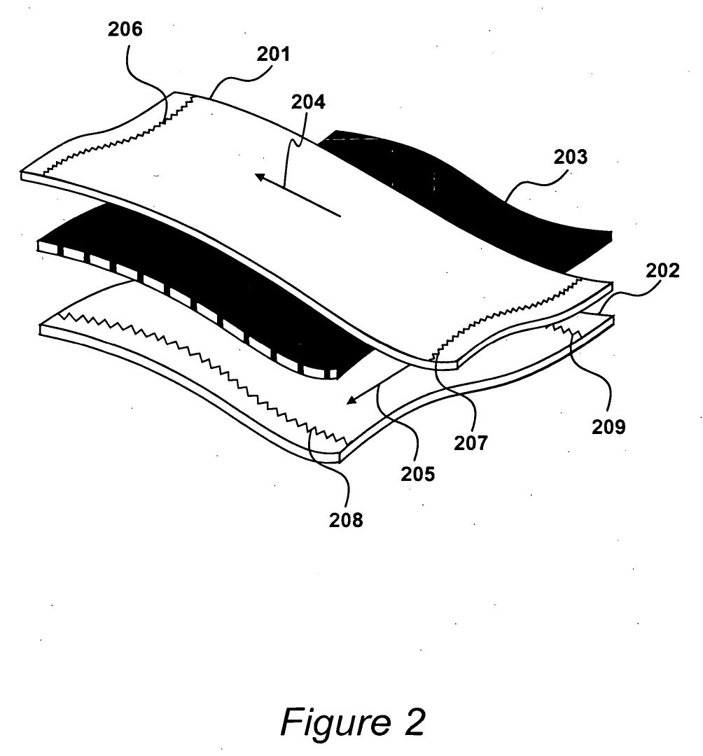

FIG. 2

Flexible layers of sensor 101 are shown in FIG. 2. The sensor 101 utilises a first conductive fabric layer 201, a second conductive fabric layer 202 and an intermediate separating layer 203 disposed between the first conductive fabric layer 201 and the second conductive fabric layer 202. The intermediate separating layer 203 is configured to separate the first conductive fabric layer 201 and the second conductive fabric layer 202 in the absence of a mechanical interaction with the position sensor 101. The intermediate separating layer 203 is also penetrable by one or both of the first conductive fabric layer 201 and the second conductive fabric layer 202 during a mechanical interaction to allow the first conductive fabric layer 201 and the second conductive fabric layer 202 to make electrical contact.

The first conductive fabric layer 201 includes conductive fibres arranged such that the first conductive layer is conductive in a first direction 204, along the layer. The second conductive fabric layer 202 also includes conductive fibres arranged such that the second conductive layer is conductive in a second direction 205, along the layer. In the arrangement shown, the first direction 204 and the second direction 205 are substantially perpendicular. The conductive fabric layers may have a weave, knit or felt construction.

The first conductive fabric layer 201 is provided with a first conductor element 206 and a second conductor element 207, positioned at opposed ends of a conductive path extending in the first direction 204. Similarly, the second conductive fabric layer 202 is provided with a third conductor element 208 and a fourth conductor element 209, positioned at opposed ends of a conductive path extending in the second direction 205.

When a voltage is applied across the first and second conductor elements 206, 207 a voltage gradient appears across the first conductive fabric layer 201. When a mechanical interaction takes place, the first conductive fabric layer 201 is brought into electrical contact with the second conductive fabric layer 202, and the actual voltage applied to the second conductive fabric layer 202 will depend upon the position of the mechanical interaction along the first conductive path. This voltage can be measured to provide a first positional co-ordinate of the mechanical interaction. Similarly, when a voltage is applied across the third and fourth conductor elements 208, 209 a voltage gradient appears across the second conductive fabric layer 202. When a mechanical interaction takes place, the second conductive fabric layer 202 is brought into electrical contact with the first conductive fabric layer 201, and the actual voltage applied to the first conductive fabric layer 201 will depend upon the position of the mechanical interaction along the second conductive path. This voltage can be measured to provide a second positional co-ordinate of the mechanical interaction.

Thus, with reference to these two voltage measurements, it is possible to identify X-axis and Y-axis co-ordinates of a mechanical interaction within a sensing area. WO 00/72240 A1 discloses a position sensor and suitable control circuit operations for determining positional coordinates of mechanical interactions.

The conductor elements 206, 207, 208, 209 of the position sensor 101 are each fabricated from a length of electrically conductive thread machined to form a conductive track of stitches.

It can be seen from FIG. 2 that the first and second conductor elements 206, 207 extend in a direction substantially perpendicular to the direction of conduction of the first conductive layer. Similarly, the third and fourth conductor elements 208, 209 extend in a direction substantially perpendicular to the direction of conduction of the second conductive layer.

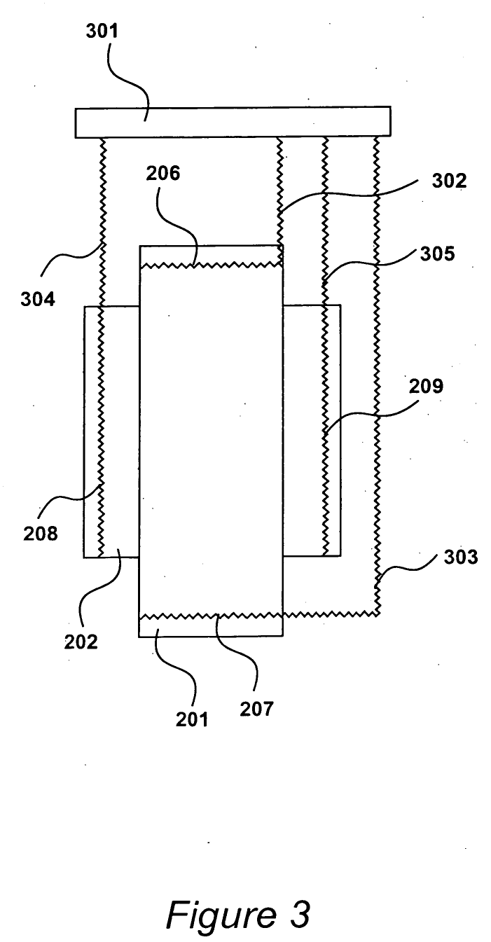

FIG. 3

FIG. 3 shows a schematic of the first and second conductive fabric layers 201, 202, in plan view.

The conductive layers are electrically connected to a control circuit 301. A first connection 302 is made between the control circuit 301 and the first conductor element 206 and a second different connection 303 is made between the control circuit 301 and the second conductor element 207. The first and second connections 302, 303 are arranged so as not to intersect. Thus, the first conductor element, the second conductor element and their respective connections do not intersect. In this way, there are two electrically distinct conductive tracks between the control circuit 301 and the first conductive layer 201.

A third connection 304 is made between the control circuit 301 and the third conductor element 208 and a second different connection 305 is made between the control circuit 301 and the second conductor element 209. The third and fourth connections 304, 305 are arranged so as not to intersect. Thus, the third conductor element, the fourth conductor element and their respective connections do not intersect. In this way, there are two electrically distinct conductive tracks between the control circuit 301 and the second conductive layer 202.

According to the electrical arrangement shown in FIG. 3, the first and second electrical conductor elements do not overlap the third and fourth electrical conductor elements.

To achieve this feature, the first conductive fabric layer 201 has a pair of conductor elements 206, 207 that each have a length dimension that is smaller than the minimum distance between the pair of conductor elements 208, 209 of the second conductive fabric layer 202. The second conductive fabric layer 202 also has a pair of conductor elements 208, 209 that each have a length dimension that is smaller than the minimum distance between the pair of conductor elements 206, 207 of the first conductive fabric layer 201.

According to the specific arrangement shown in FIG. 3, the first conductive layer 201 has an elongate rectangular shape, the second conductive layer 202 has a substantially square shape, and the first conductive layer 201 extends over the second conductive layer 202, between the pair of conductor elements 208, 209 of the second conductive layer 202. In other arrangements the conductive layers overlap, and may have the same shape and dimensions, provided that the conductor elements of a conductive layer do not intersect and the conductor elements of the two conductive layers do not overlap.

The conductive layers 201, 202 may be used in a sensor having a three layer construction as described with reference to FIGS. 2 and 3, or in a sensor having a five layer construction as described in WO 00/72240 A1. Suitable control circuit operations for a three layer sensor are also described in GB 2 350 431 B, whilst suitable control circuit operations for a five layer sensor are also described in U.S. Pat. No. 6,452,479 B.

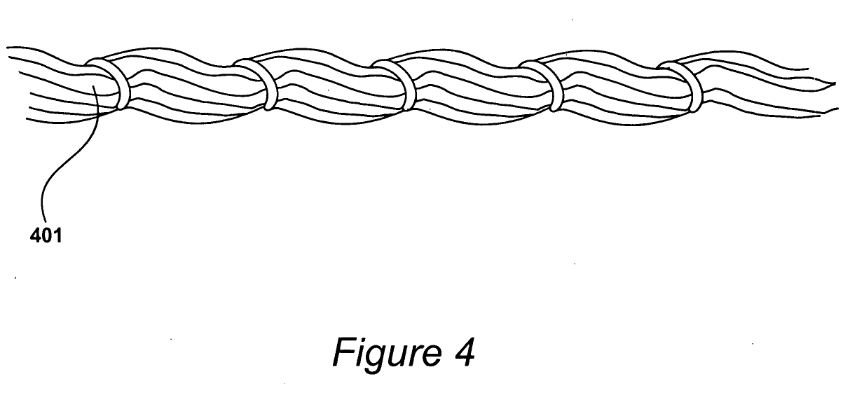

FIG. 4

An electroconductive thread is shown in FIG. 4. Conductive thread 401 is a multifilament thread, twisted to provide a diameter suitable for the thread to be stitched with a sewing machine. The electrically conductive thread 401 is constructed from a conventional yarn having a conductive surface, such as silver plated nylon or carbon coated nylon.

It is to be appreciated that an electrical current may flow along the conductive thread 401. The conductive thread 401 may therefore be stitched into a non-conductive or conductive fabric layer to provide a conductive track of stitches.

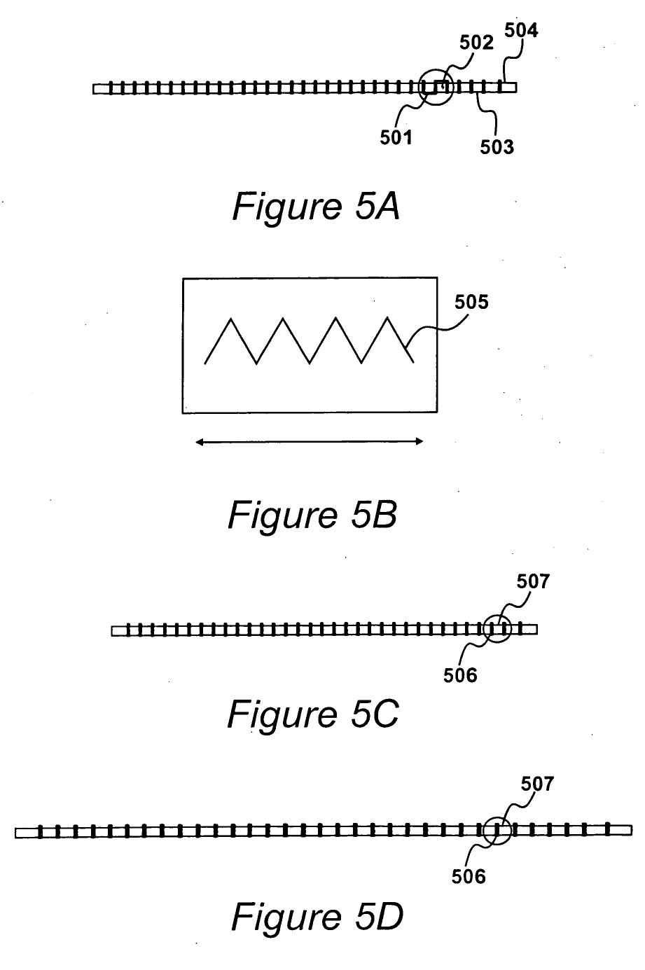

FIGS. 5A, 5B, 5C & 5D

FIG. 5A shows a length of conductive thread 501 stitched into a layer of conductive fabric 502. It can be seen that the conductive thread 502 passes from a first outer surface 503 of the conductive fabric layer 501 through the conductive fabric layer 502 to the other second outer surface 504. The thread then passes back through the conductive fabric layer 501 to the first outer surface 503 where the stitch pattern repeats along the row of stitches.

The stitches secure a good mechanical lock between the conductive thread and the conductive fabric. In turn, the stitches provide a uniform electrical connection between the conductive thread and the conductive fabric.

Conductive stitch track conductors are found to display good resistance to wear from flexing. The use of conductive thread and machining it into a conductive fabric to produce a conductive track of stitches is economical and convenient. Furthermore, the use of conductive stitches to produce an electrical conductor element is found to enable comparable reductions in the size of a conductor element.

A stitch pattern in shown in FIG. 5B. The zigzag stitch pattern 505 may be used in stretch sewing, in other words to provide an extensible row of stitches.

FIGS. 5C and 5D show length of conductive thread 506 stitched along a layer of conductive fabric 507 in accordance with the zigzag stitch pattern 505. In FIG. 5C, the conductive fabric 507 is shown in the at rest condition, whilst FIG. 5D shows the conductive fabric 507 after having been stretched in a direction along the row of stitches.

Using a stretch stitch when stitching a conductor member of a conductive fabric layer of a flexible sensor provides the conductor member with flexibility. This is useful for prolonging the operational life of the flexible sensor, which during use experiences repeated bending and flexing.

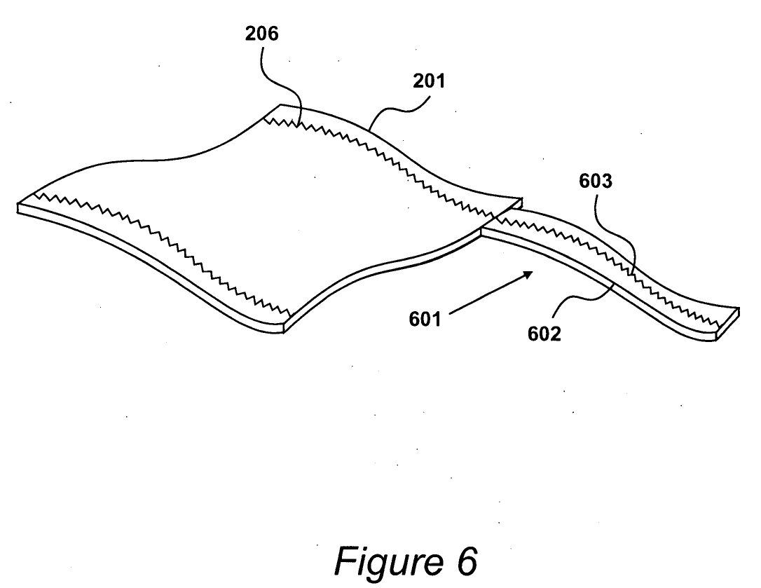

FIG. 6

FIG. 6 shows a flexible electrically conductive fabric conductor element 601. The conductor element 601 comprises a layer of electrically non-conductive fabric 602 having a length of conductive thread 603 machined therein to form a conductive track of stitches along the layer of fabric. The conductor element 601 can be used to provide an electrical connection.

According to one method of providing an electrical connection between two electrically conductive elements, a layer of fabric is connected between the two elements and a conductive thread is then machined into and along the fabric to provide a conductive track of stitches electrically connecting the two elements. According to an alternative method of providing an electrical connection between two electrically conductive elements, a conductive thread is first machined into and along a layer of fabric to provide a conductive track of stitches, and the resultant layer of fabric is then located between the two elements such that they are connected by the conductive track of stitches.

In the example shown in FIG. 6, the conductor element 601 is arranged to provide an electrical track from conductor element 206 of the first conductive fabric layer 201 of position sensor 101, suitable for connection to a control circuit.

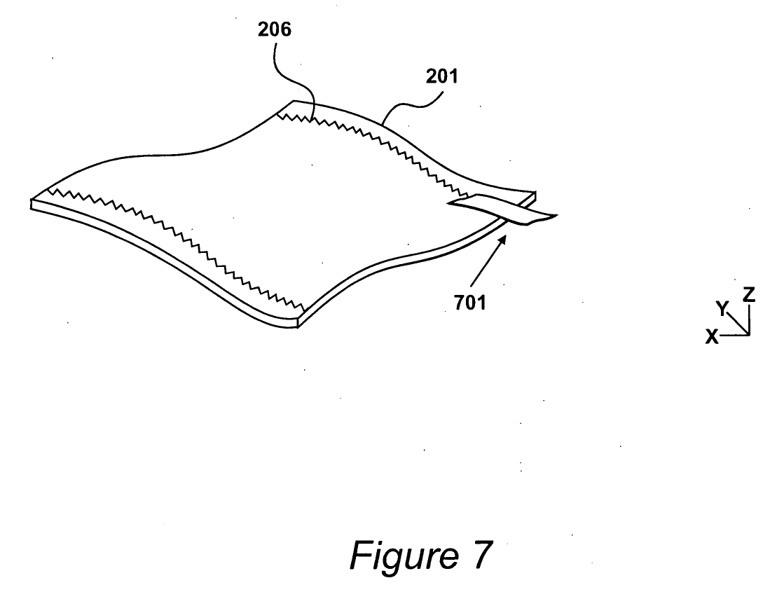

FIG. 7

FIG. 7 illustrates a different electrical track from conductor element 206 of the first conductive fabric layer 201 of position sensor 101, suitable for connection to a control circuit. Conductive track 701 takes the form of adhesive tape that is conductive in the Z-axis only. The conductive tape 701 can be adhered directly onto the surface of the conductor element.

Conductive tape 701 may take the form of a non-conductive adhesive tape in which conductive particles, for example metal spheres, are spaced apart along the length thereof. This type of conductive adhesive tape may be used to provide a connection between a conductor element and a printed circuit board.

1. A position sensor for detecting the position of a mechanical interaction, including:
a first conductive fabric layer having electrically conductive fibres incorporated therein to allow conduction in a first direction, the first conductive fabric layer having a first electrical conductor element and a second electrical conductor element positioned at opposed ends of a first conductive path extending in the first direction;
said first electrical conductor element and said second electrical conductor element each comprising a length of electrically conductive thread machined to form a conductive track of stitches that extends in a second direction substantially perpendicular to the first direction with a zigzag stitch pattern, and
the first and second electrical conductor elements do not intersect.

2. A position sensor according to claim 1, further comprising:
a second conductive fabric layer having electrically conductive fibres incorporated therein to allow conduction in the second direction, the second conductive fabric layer having a third electrical conductor element and a fourth electrical conductor element positioned at opposed ends of a second conductive path extending in the second direction;
electrically insulating separating means disposed between the first conductive fabric layer and the second conductive fabric layer to separate the two conductive fabric layers when no pressure is applied to the sensor and to allow electrical conduction between the two conductive fabric layers under the application of pressure,
the third and fourth electrical conductor elements each comprise a length of electrically conductive thread machined to form a conductive track of stitches that extends in the first direction substantially perpendicular to the second direction, and
the third and fourth electrical conductor elements do not intersect; and
the first and second electrical conductor elements do not overlap the third and fourth electrical conductor elements.

3. A position sensor according to claim 1 comprising a conductive track of stitches in which the electrically conductive thread is constructed from silver plated nylon or carbon coated nylon.

4. A flexible fabric conductor element comprising:
a layer of electrically conductive fabric having electrically conductive fibres incorporated therein to allow conduction in a first direction,
the layer of electrically conductive fabric having a length of conductive thread machined therein to form a conductive track of zigzag stitches along the layer of electrically conductive fabric, the conductive track of stitches extending in a second different direction substantially perpendicular to the first direction.

5. A flexible fabric conductor element according to claim 4 comprising a conductive track of stitches in which the electrically conductive thread is constructed from silver plated nylon or carbon coated nylon.

6. A flexible fabric conductor element comprising:
a layer of electrically non-conductive fabric having a length of conductive thread machined therein to form a zigzag conductive track of stitches along the layer of fabric.

7. A flexible fabric conductor element according to claim 6 comprising a conductive track of stitches in which the electrically conductive thread is constructed from silver plated nylon or carbon coated nylon.

8. A flexible fabric conductor element according to claim 5 comprising a conductive track of stitches in which the electrically conductive thread is stitched in accordance with a zigzag stitch pattern.

9. A flexible fabric conductor element according to claim 6 comprising a conductive track of stitches in which the electrically conductive thread is stitched in accordance with a zigzag stitch pattern.

10. A flexible fabric conductor element according to claim 7 comprising a conductive track of stitches in which the electrically conductive thread is stitched in accordance with a zigzag stitch pattern.
